(19) United States
(12) Patent Application Publication
(10) Pub. No.: US 2022/0175190 A1
(43) Pub. Date: Jun. 9, 2022

(54) COOKING VESSEL HAVING STIRRING FUNCTION

(71) Applicant: HONG SAN LIGHT METAL CO., LTD., Busan (KR)

(72) Inventors: Gyung Chan SEO, Busan (KR); Wol Shik SEO, Busan (KR)

(73) Assignee: HONG SAN LIGHT METAL CO., LTD., Busan (KR)

(21) Appl. No.: 17/604,763

(22) PCT Filed: Apr. 10, 2020
(86) PCT No.: PCT/KR2020/004886

§ 371 Date: Oct. 19, 2021

(30) Foreign Application Priority Data
Apr. 19, 2019 (KR) 10-2019-0045970

(51) Int. Cl. A47J 43/044; A47J 43/07; A47J 36/06

(52) U.S. Cl. CPC A47J 43/044; A47J 36/06; A47J 43/0705

(57) ABSTRACT

A cooking vessel having a stirring function includes a vessel body, a main lid and a rotating member. The vessel body is formed with a cooking space having a top portion open, and a food material to be cooked is accommodated in the vessel body. The main lid is configured to seal the cooking space of the vessel body and has an upper surface formed with a fastening hole. The operating means is formed with a housing mounted at the fastening hole of the main lid, a motor provided inside the housing and having a motor shaft, and a power supply part provided at a first side of an inside of the housing and configured to supply electricity to the motor. The rotating member has an upper portion formed with a shaft coupling hole, and a stirring blade configured to stir the food material inserted inside the vessel body.

### CROSS REFERENCE TO THE RELATED APPLICATIONS

This application is the national phase entry of International Application No. PCT/KR2020/004886, filed on Apr. 10, 2020, which is based upon and claims priority to Korean Patent Application No. 10-2019-0045970, filed on Apr. 19, 2019, the entire contents of which are incorporated herein by reference.

### TECHNICAL FIELD

The present disclosure relates to a cooking vessel having a stirring function. More particularly, the present disclosure relates to a cooking vessel having a stirring function, the cooking vessel being capable of stirring various food materials via a stirring blade when the food materials are fried or boiled, so as to improve cooking convenience, thereby having improved maintenance such as that of washing while having high usability.

### BACKGROUND

In general, cooking utensils such as frying pans and pots are used to prepare a food by cooking various food materials, and subsidiary cooking utensils such as spatulas and stirrers are used to ensure that the food being cooked is not burned and is also cooked evenly. These cooking utensils include a cooking utensil of a type such as a type using direct firing to cook, a type using electricity to cook, and so on.

Accordingly, when the food that is easily stuck at a bottom of a vessel if it does not be continuously stirred is cooked, a cook should continuously watch the food and should continuously stir the food by using a subsidiary cooking utensil such as the stirrer. Therefore, it is cumbersome and there is a disadvantage that physical fatigue is significantly increased.

In order to solve this problem, a cooking container lid having a stirring function disclosed in Korean Patent No. 10-1964554 (published on Apr. 1, 2019) has been proposed. Referring to this publication, an operating means is provided at a lid, and a rotating shaft having a stirring blade is provided inside a container, so that convenience of cooking is improved by rotating the rotating shaft with a power of the operating means such that a food material is stirred. However, there is a disadvantage that a fastening of a nut portion that fastens the housing of the operating means is required to be released and the housing in which electrical components are mounted is required to be separated from the lid in order to perform a washing. Furthermore, there is a disadvantage that a component that functions as a handle for holding the lid is removed when the operating means is separated from the lid.

### SUMMARY

### Technical Problem

Accordingly, the present disclosure has been made keeping in mind the above problems occurring in the related art, and the present disclosure is intended to propose a cooking vessel having a stirring function, the cooking vessel being capable of stirring various food materials via a stirring blade when the food materials are fried or boiled, so as to improve cooking convenience, thereby having improved maintenance such as that of washing while having high usability.

### Technical Solution

In order to achieve the above objective, according to one aspect of the present disclosure, there is provided a cooking vessel having a stirring function, the cooking vessel including: a vessel body formed with a cooking space having a top portion open and in which a food material to be cooked is accommodated; a main lid configured to seal the cooking space of the vessel body and having an upper surface thereof formed with a fastening hole; an operating means formed with a housing mounted at the fastening hole of the main lid, a motor provided inside the housing and having a motor shaft that protrudes to a lower portion of the housing, and a power supply part provided at a first side of an inside of the housing and configured to supply electricity to the motor; and a rotating member having an upper portion thereof formed with a shaft coupling hole so as to be axially coupled to the motor shaft, and having a stirring blade configured to stir the food material that is inserted inside the vessel body, and the stirring blade that extends downward to the inside of the vessel body, wherein the housing is formed of a fixed housing that is mounted at the fastening hole of the main lid and has a center thereof provided with a penetration hole that is penetrated in a vertical direction, and a separable housing having the motor and the power supply part therein and being fitted and inserted into the penetration hole of the fixed housing.

Preferably, a protrusion portion may be formed at a bottom surface of the vessel body so as to fasten a lower surface of the rotating member to the protrusion portion by fitting such that the rotating member maintains an upright state and a rotating operation of the rotating member is supported.

Preferably, a discharge hole for discharging liquid such as oil that is generated during a cooking process may be formed at a first side of the vessel body, the discharge hole may be provided with a plug for opening or closing the discharge hole, and an extension portion that extends downward may be formed at an end portion of the discharge hole so that discharged liquid is induced to be vertically dropped.

Preferably, an insertion hole allowing the food material to be inserted during a cooking process may be formed at a first side of the main lid, the main lid may further include an auxiliary lid for opening or closing the insertion hole, and a packing portion that is in close contact with the auxiliary lid so that the auxiliary lid is prevented from being unexpectedly separated may be provided at an inner wall of the insertion hole.

Preferably, a first handle may be formed at the fixed housing so that a user can easily hold the fixed housing, a placing groove open upward may be formed at the first handle, and a second handle allowing the user to hold the separable housing and also to be placed on the placing groove that is formed at the first handle may be further formed at the separable housing.

Preferably, a locking step may be formed at a rear wall of the placing groove, and may allow an upper surface of the second handle that is placed on the placing groove to be in close contact with the placing groove so that the separable housing is prevented from being unexpectedly separated.

Preferably, a drainage hole that is penetrated in a horizontal direction may be formed in the shaft coupling hole that is formed in an upper surface of the rotating member, thereby facilitating the washing of the shaft coupling hole.

Preferably, an auxiliary stirring rod that is separable may be further provided at a first side of the stirring blade so that the auxiliary stirring rod is to be used being separated from the stirring blade or being coupled to the stirring blade depending on types of food materials.

### Advantageous Effects

According to the present disclosure, when the various food materials are fried or boiled, the food materials are stirred via the stirring blade, so that the convenience of cooking is improved and high usability may be realized. Further, the housing of the operating means is formed of the fixed housing and the separable housing, and the motor and the power supply part are provided at the separable housing, so that the motor and the power supply part are easily separated, thereby improving maintenance such as that of washing.

### BRIEF DESCRIPTION OF THE DRAWINGS

FIG. 1 is a partially exploded perspective view illustrating a cooking vessel having a stirring function according to an exemplary embodiment of the present disclosure.

FIGS. 2A and 2B are longitudinal sectional views illustrating an inside of a vessel body according to an exemplary embodiment of the present disclosure.

FIGS. 3A and 3B are longitudinal sectional views illustrating a main lid and an auxiliary lid according to an exemplary embodiment of the present disclosure.

FIG. 4 is a perspective view illustrating an operating means according to an exemplary embodiment of the present disclosure.

FIG. 5A is an exploded perspective view illustrating an housing of the operating means according to an exemplary embodiment of the present disclosure, FIG. 5B is an exploded longitudinal sectional view illustrating the same, and FIG. 5C is an assembled longitudinal sectional view illustrating the same.

FIGS. 6A and 6B are longitudinal sectional views schematically illustrating a coupling relationship of the operating means according to an exemplary embodiment of the present disclosure.

FIG. 7A is a perspective view illustrating a rotating member according to an exemplary embodiment of the present disclosure, FIG. 7B is a longitudinal sectional view illustrating the same, and FIG. 7C is a longitudinal sectional view illustrating a coupling relation of the rotating member according to the exemplary embodiment of the present disclosure.

FIGS. 8A and 8B are longitudinal sectional views illustrating an usage state of the cooking vessel having the stirring function according to an exemplary embodiment of the present disclosure.

### DETAIL DESCRIPTION OF THE EMBODIMENTS

Hereinafter, a cooking vessel having a stirring function of the present disclosure will be described in detail with reference to the accompanying drawings.

Prior to the description, it should be understood that the terms used in the specification and the appended claims should not be construed as limited to general and dictionary meanings, but interpreted on the basis of the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the present disclosure, so it should be understood that other equivalents and modifications could be made thereto without departing from the scope of the present disclosure.

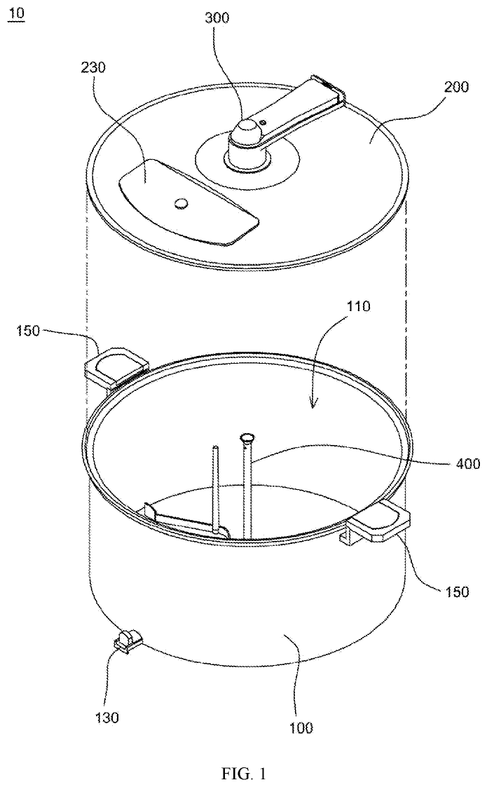

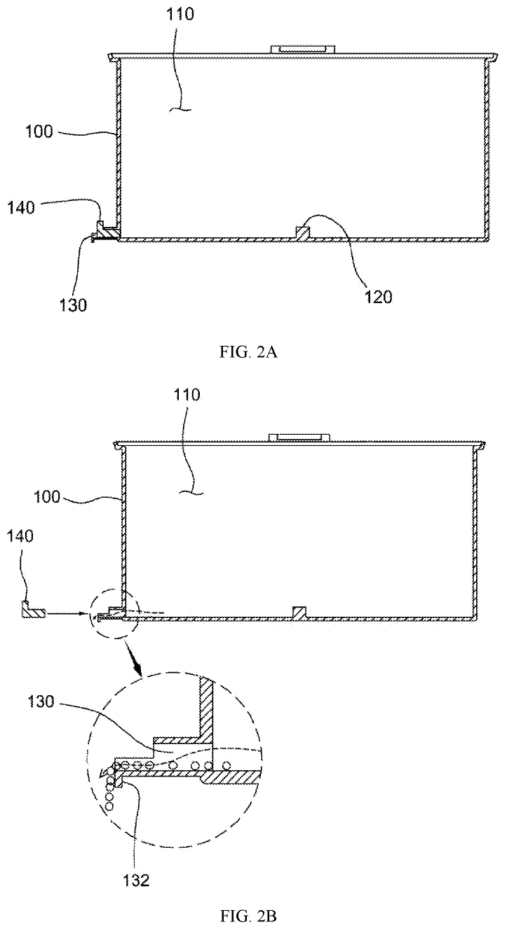

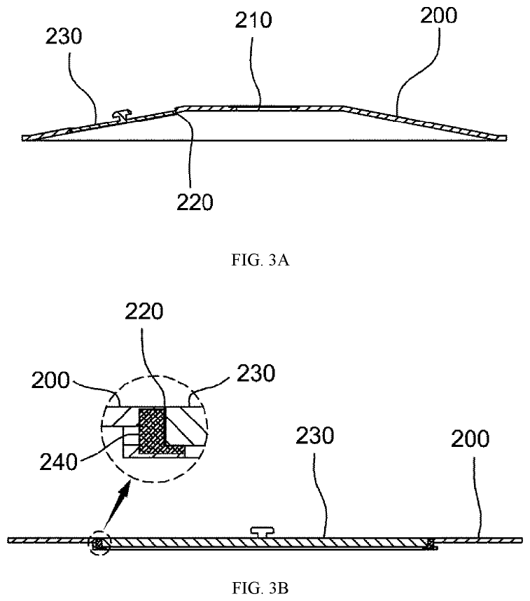

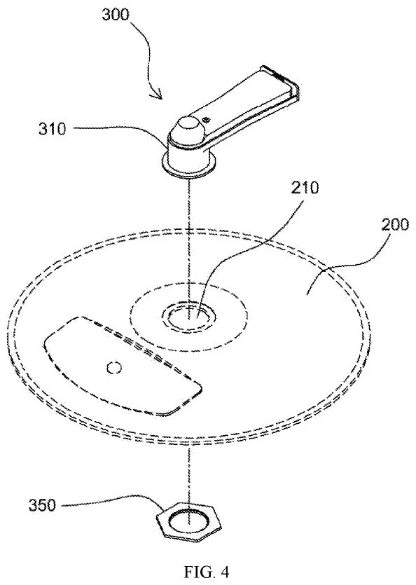

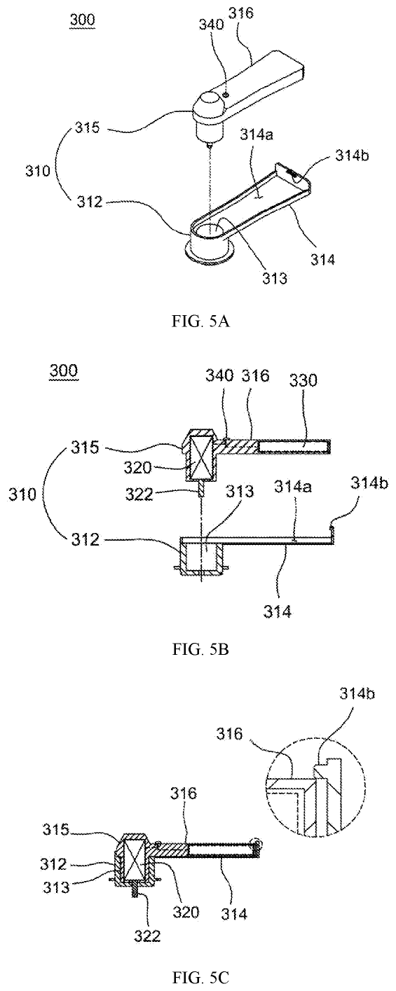

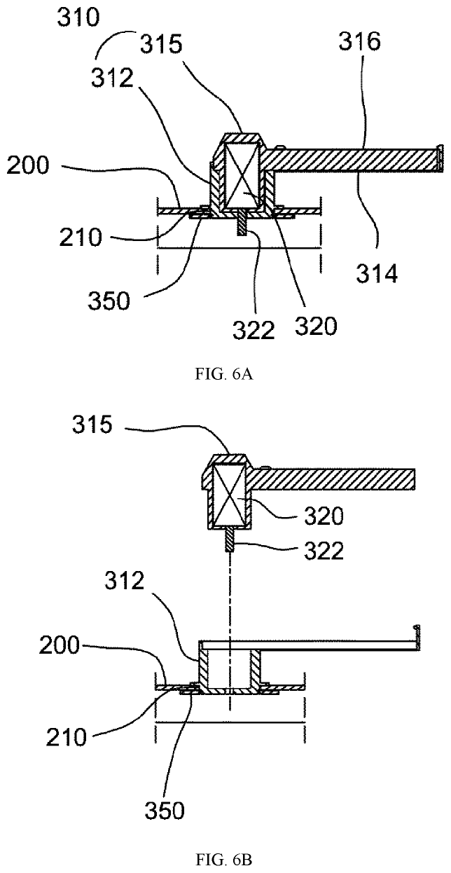

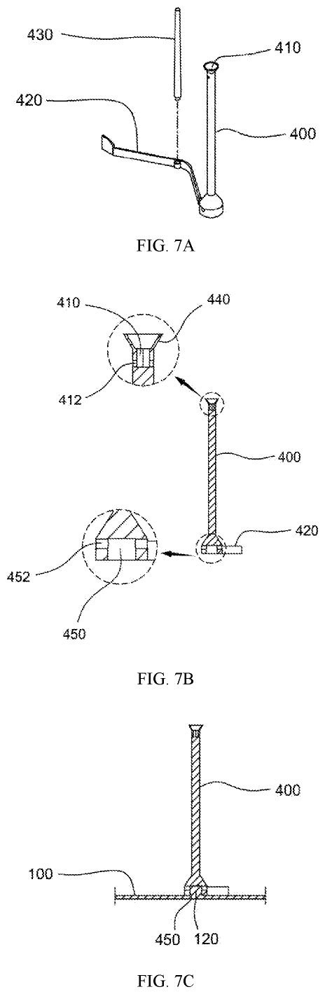

FIG. 1 is a partially exploded perspective view illustrating a cooking vessel having a stirring function according to an exemplary embodiment of the present disclosure. FIGS. 2A and 2B are longitudinal sectional views illustrating an inside of a vessel body according to an exemplary embodiment of the present disclosure. FIGS. 3A and 3B are longitudinal sectional views illustrating a main lid and an auxiliary lid according to an exemplary embodiment of the present disclosure. FIG. 4 is a perspective view illustrating an operating means according to an exemplary embodiment of the present disclosure. FIG. 5A is an exploded perspective view illustrating a housing of the operating means according to an exemplary embodiment of the present disclosure, FIG. 5B is an exploded longitudinal sectional view illustrating the same, and FIG. 5C is an assembled longitudinal sectional view illustrating the same. FIGS. 6A and 6B are longitudinal sectional views schematically illustrating a coupling relationship of the operating means according to an exemplary embodiment of the present disclosure. FIG. 7A is a perspective view illustrating a rotating member according to an exemplary embodiment of the present disclosure, FIG. 7B is a longitudinal sectional view illustrating the same, and FIG. 7C is a longitudinal sectional view illustrating a coupling relation of the rotating member according to the exemplary embodiment of the present disclosure.

Referring to FIG. 1, a cooking vessel 10 having a stirring function according to the present disclosure includes a vessel body 100, a main lid 200, an operating means 300, and a rotating member 400.

Firstly, in the vessel body 100, a cooking space 110 having a top portion open and in which a food material to be cooked is accommodated is formed. Further, as illustrated in FIGS. 2A and 2B, a protrusion portion 120 that protrudes upward is formed at a center of a bottom surface of the vessel body 100. At this time, although it is not illustrated on the protrusion portion 120, the protrusion portion 120 may be covered with a cover of a silicone material so as to prevent noise or abrasion. In addition, at a first side of a lower surface of the vessel body 100, a discharge hole 130 is formed for discharging liquid such as oil that is generated during a cooking process. Further, as illustrated in an enlarged view of FIG. 2B, it is more preferable that the discharge hole 130 is provided with a plug 140 for opening or closing the discharge hole 130, and it is more preferable that an extension portion 132 that extends downward is formed at an end portion of the discharge hole 130 so that discharged liquid is induced to be vertically dropped. When the extension portion 132 is not formed, the discharged liquid may be moved to the bottom surface of the vessel body 100 along a lower surface of the discharge hole 130 and may be dropped to cooking flame. Therefore, it is preferable to fundamentally prevent the discharged liquid from being dropped to the cooking flame.

In addition, opposite sides of an upper portion of the vessel body 100 is further provided with a sliding locking device 150 that serves as a handle when the vessel body 100 is moved and that is also for fastening the main lid 200 to be placed on the top portion of the vessel body 100. Since this sliding locking device 150 is widely known conventionally, a detailed description of the sliding locking device 150 will be omitted at the present disclosure.

Next, the main lid 200 seals the cooking space 110 by being placed on a top surface of the vessel body 100. At a first side of the top surface of the vessel body 100, preferably at a center of the top surface of the vessel body 100, is formed with a fastening hole 210 as illustrated in FIGS. 3A and 3B. The main lid 200 may be formed in various types such as a recessed hemispherical type and a flat type, and may be formed of various materials such as a metal material, a glass material, and the like.

In addition, at the first side of the main lid 200, an insertion hole 220 that allows the food material to be inserted without opening the main lid 200 during the cooking process is formed, and an auxiliary lid 230 for opening or closing the insertion hole 220 is further included. Further, at an inner wall of the insertion hole 220, a packing portion 240 that is in close contact with the auxiliary lid 230 so that the auxiliary lid 230 is prevented from being unexpectedly separated is provided.

Next, as illustrated in FIG. 4, the operating means 300 is provided to generate rotating force by being mounted on the fastening hole 210 of the main lid 200. Further, as illustrated in FIGS. 5A to 5C, the operating means 300 includes a housing 310, a motor 320, and a power supply part 330.

The housing 310 is mounted on the fastening hole 210 of the main lid 200. Further, the housing 310 includes a fixed housing 312 on which a penetration hole 313 of which an upper and lower portions are penetrated is formed in a center portion of the fixed housing 312, and includes a separable housing 315 that is fitted and inserted into the penetration hole 313 of the fixed housing 312.

The motor 320 and the power supply part 330 are mounted on the separable housing 315. Further, the motor 320 is mounted such that a motor shaft 322 protrudes downward, and the power supply part 330 is electrically connected to the motor 320 from a first side of the separable housing 315 so as to supply an operating power of the motor 320. In addition, at a top surface of the separable housing 315, an operation switch 340 for controlling an operation of the motor 320 is provided. At this time, it is most preferable that the power supply part 330 uses a rechargeable battery or a replaceable battery, but it is also possible to supply a power through an electrical line. When the replaceable battery is used in the power supply part 330, it is natural to provide an opening and closing type cover or a component not designated by a reference numeral, thereby allowing the replaceable battery to be easily replaced.

Meanwhile, a first handle 314 is formed at the fixed housing 312 so that a user can easily hold the fixed housing 312, and a placing groove 314a open upward is formed at the first handle 314. Further, at the separable housing 315, it is preferable that a second handle 316 that allows the user to hold the separable housing 315 and also to be placed on the placing groove 314a formed at the first handle 314 is further formed. Moreover, a locking step 314b is formed at a rear wall of the placing groove 314a and allows the second handle 316 to be in close contact with the placing groove 314a, so that the separable housing 315 is prevented from being unexpectedly separated.

As illustrated in FIGS. 6A and 6B, in the operating means 300 as described above, the fixed housing 312 of the housing 310 is inserted downward into the fastening hole 210 of the main lid 200, and is mounted at the main lid 200 via a fixing member 350 such as a nut that is positioned at a bottom surface of the main lid 200. At this time, depending on types of the fixing member 350, it should be understood that the fixed housing 312 may also be mounted as a separable type or a non-separable type. When the separable housing 315 is fitted and inserted into the penetration hole 313 of the fixed housing 312 that is mounted at the main lid 200, the motor shaft 322 of the motor 320 that is provided inside the separable housing 315 protrudes downward below the main lid 200 and is connected to the rotating member 400 that will be described later, thereby transferring the rotating force.

Meanwhile, opening or lifting the main lid 200 by the user may be implemented by simultaneously holding the first and second handles 314 and 316 of the fixed housing 312 and the separable housing 315, and when washing process is needed, performing the washing process is immediately possible by lifting the separable housing 315 only and separating the separable housing 315 from the fixed housing 312. Although the separable housing 315 is separated from the fixed housing 312, the fixed housing 312 is in a state of being fastened to the main lid 200. Therefore, the user may easily perform a carrying process or the washing process by holding the fixed housing 312.

At this time, since the separable housing 315 is provided with being in a state of being placed on the placing groove 314a of the fixed housing 312, it is natural that the separable housing 315 maintains a stable state in which the separable housing 315 is not rotated with the motor 320 and a sway of the separable housing 315 is not caused almost at all.

Finally, as illustrated in FIGS. 7A and 7B, a shaft coupling hole 410 is formed in an upper portion of the rotating member 400 so that the rotating member 400 is axially coupled to the motor shaft 322 of the motor 320, and a stirring blade 420 that extends downward to the inside of the vessel body 100 and is for stirring the food material that is inserted inside the vessel body 100 is formed at a first side of a lower portion of the rotating member 400. At this time, a guide tube 440 having an internal diameter that gradually increases toward the upper side thereof is provided at an upper portion of the shaft coupling hole 410, so that rotating member 400 is easily guided to be axially connected to the motor shaft 322. In addition, it is more preferable that an auxiliary stirring rod 430 that is separable is further provided at a first side of the stirring blade 420 so that the auxiliary stirring rod 430 is to be used being separated from the stirring blade 420 or being coupled to the stirring blade 420 depending on types of food materials. For example, during cooking of noodles such as guksu (Korean noodle), when the auxiliary stirring rod 430 is coupled to the stirring blade 420 and used, it has an advantage that the noodles are stirred while the noodles are prevented from being twisted. Further, during cooking meat such as chicken, when the auxiliary stirring rod 430 is separated from the stirring blade 420, it has an advantage that a jamming phenomenon does not occur.

In addition, a drainage hole 412 that is penetrated in a horizontal direction is formed in the shaft coupling hole 410 that is formed in the upper portion of the rotating member 400. The drainage hole 412 is implemented so as to allow the washing process to be easily performed by discharging washing water through the drainage hole 412 when the washing water is supplied to the shaft coupling hole 410 if food waste is fitted at the shaft coupling hole 410 or liquid is introduced to the shaft coupling hole 410. Further, the drainage hole 412 is also implemented so that the rotating member 400 does not receive pressure when the rotating member 400 is axially coupled to the motor shaft 322.

Meanwhile, a mounting groove 450 is formed at a lower surface of the rotating member 400. As illustrated in FIG. 7C, the mounting groove 450 is provided such that the rotating member 400 is fitted and mounted on the protrusion portion 120 that is formed on the bottom surface of the vessel body 100. Further, when the rotating member 400 is fitted and mounted on the protrusion portion 120 via the mounting groove 450, the rotating member 400 will not be unexpectedly dropped at the inside of the vessel body 100, and will be supported so as to be stably rotated while being rotatably operated. It is more preferable that another drainage hole 452 that is penetrated in the horizontal direction is formed at the mounting groove 450 such that the washing process is easily performed.

Now, an usage state of the cooking vessel 10 having the stirring function of the present disclosure configured as described above will be described hereinafter.

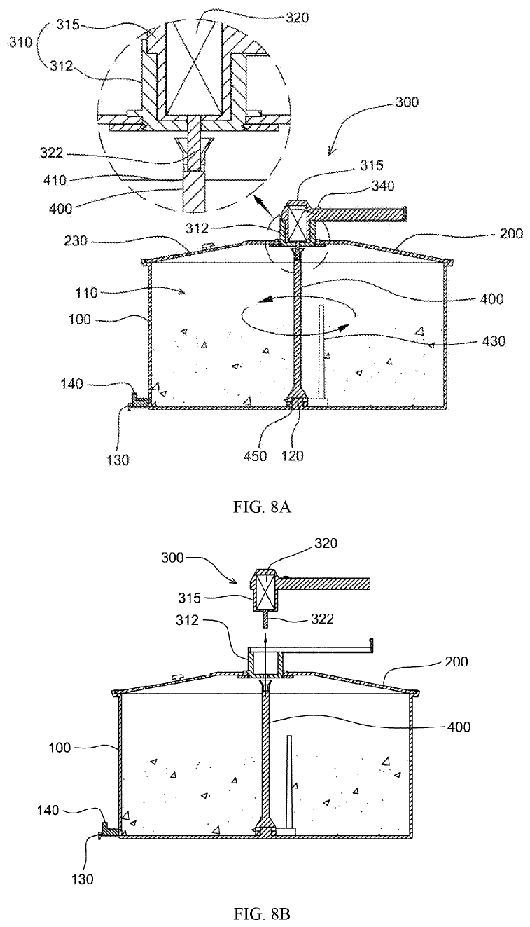

FIGS. 8A and 8B are longitudinal sectional views illustrating an usage state of the cooking vessel having the stirring function according to an exemplary embodiment of the present disclosure.

First, referring to FIG. 8A, the rotating member 400 is provided inside the vessel body 100, that is, the mounting groove 450 formed at the lower surface of the rotating member 400 is inserted into the protrusion portion 120 formed at the bottom surface of the vessel body 100, and the food material that is to be cooked is inserted into the cooking space 110, and then the cooking space 110 is sealed by covering with the main lid 200 on which the operating means 300 is mounted. In the process of covering the main lid 200, the motor shaft 322 of the motor 320 that is provided at the separable housing 315 will be naturally inserted into and axially coupled to the shaft coupling hole 410 that is formed in the upper portion of the rotating member 400 provided inside the vessel body 100. Then, the food material is cooked by heating the lower surface of the vessel body 100 using a heating device such as a gas range. Meanwhile, it is most preferable that the shaft of the motor 320 is formed in a polygonal rod type having at least six corners and the shaft coupling hole 410 is formed in a polygonal groove having corresponding corners so that the axial coupling is naturally realized during the motor shaft 322 being rotated even if the exact position does not match while the axial coupling is performed.

At the same time, when the motor 320 is rotated through the operation switch 340 that is provided at the separable housing 315, the rotating member 400 axially coupled to the motor 320 is rotated and the food material is stirred, so that the food material does not stick or burn, thereby enabling convenient cooking. In particular, by using the auxiliary lid 230 provided at the main lid 200, additional condiments and additional food materials will be added without directly opening the main lid 200 during the cooking process, so that it is self-evident that the convenience of the cooking may be further improved. In order to discharge oil generated during the cooking of the meat to the outside, the oil will be easily discharged by separating the plug 140 that closes the discharge hole 130 from the discharge hole 130. Further, since the extension portion 132 is formed at the end portion of the discharge hole 130, the oil is guided to be vertically dropped and a phenomenon that the oil flows into the cooking flame by moving along the bottom surface of the vessel body 100 is fundamentally prevented, so that there is an advantage that the cooking vessel 10 can be safely used.

When the cooking process is completed and the washing of the cooking vessel 10 is needed, there is no need to separate entire housing 310, and the cooking vessel 10 becomes a washable state by lifting only the separable housing 315 in which electrical components are mounted and separating the separable housing 315 from the fixed housing 312. Even if the separable housing 315 is separated from the fixed housing 312, the fixed housing 312 is mounted at the main lid 200. Therefore, by holding the fixed housing 312, the user can easily handle the cooking vessel 10 when the user opens or closes the main lid 200 or when the washing process is performed.

As a result, in the present disclosure, an integrated type is not implemented to the housing 310 and a separable type is implemented to the housing 310, and the motor 320 and the power supply part 330 that are components not able to perform the washing thereto are provided at the separable housing 315, so that only the separable housing 315 is separated from the fixed housing 312 during the washing process or the carrying process, thereby increasing the convenience of using. Further, since the fixed housing 312 provided at the main lid 200 with being in the mounted state is served as the handle, the convenience of use is maximized.

The foregoing description has described rather broadly the features and technical advantages of the present disclosure in order to allow the following claims of the invention to be better understood. Additional features and advantages that constitute the claims of the present disclosure will be described in detail below. It should be appreciated by those skilled in the art that the disclosed concepts and specific embodiments of the present disclosure may be used immediately as a basis for designing or modifying other structures to accomplish the invention and similar purposes.

Furthermore, the concepts and embodiments of the present disclosure disclosed herein may be used by those skilled in the art as a basis for modifying or designing other structures to accomplish the same purposes of the present disclosure, and such equivalent modifications or alterations may be made without departing from the spirit and scope of the present disclosure described in the attached claims.

### INDUSTRIAL APPLICABILITY

The cooking vessel having the stirring function of the present disclosure is capable of being generally used in the cooking industry, and be thus industrially applicable.

What is claimed is:

1. A cooking vessel having a stirring function comprising:
a vessel body formed with a cooking space having a top portion open, wherein a food material to be cooked is accommodated in the vessel body;
a main lid configured to seal the cooking space of the vessel body and having an upper surface formed with a fastening hole;
an operating means formed with a housing mounted at the fastening hole of the main lid, a motor provided inside the housing and having a motor shaft, and a power supply part provided at a first side of an inside of the housing and configured to supply electricity to the motor, wherein the motor shaft protrudes to a lower portion of the housing; and
a rotating member having an upper portion formed with a shaft coupling hole to be axially coupled to the motor shaft, and having a stirring blade configured to stir the food material inserted inside the vessel body, wherein the stirring blade extends downward to an inside of the vessel body;
wherein the housing is formed of a fixed housing and a separable housing, the fixed housing is mounted at the fastening hole of the main lid and has a center provided with a penetration hole penetrated in a vertical direction, the motor and the power supply part are in the separable housing, and the separable housing is fitted and inserted into the penetration hole of the fixed housing.

2. The cooking vessel of claim 1, wherein a protrusion portion is formed at a bottom surface of the vessel body to fasten a lower surface of the rotating member to the protrusion portion by fitting, wherein the rotating member maintains an upright state and a rotating operation of the rotating member is supported.

3. The cooking vessel of claim 1, wherein a discharge hole for discharging liquid such as oil generated during a cooking process is formed at a first side of the vessel body, the discharge hole is provided with a plug for opening or closing the discharge hole, and an extension portion is formed at an end portion of the discharge hole and extends downward, wherein discharged liquid is induced to be vertically dropped.

4. The cooking vessel of claim 1, wherein an insertion hole allowing the food material to be inserted during a cooking process is formed at a first side of the main lid, the main lid further comprises an auxiliary lid for opening or closing the insertion hole, and a packing portion is provided at an inner wall of the insertion hole, wherein the packing portion is in close contact with the auxiliary lid to prevent the auxiliary lid from being unexpectedly separated.

5. The cooking vessel of claim 1, wherein a first handle is formed at the fixed housing to allow a user to easily hold the fixed housing, a placing groove open upward is formed at the first handle, and a second handle allowing the user to hold the separable housing and to be placed on the placing groove formed at the first handle is formed at the separable housing.

6. The cooking vessel of claim 5, wherein a locking step is formed at a rear wall of the placing groove, and allows an upper surface of the second handle placed on the placing groove to be in close contact with the placing groove, wherein the separable housing is prevented from being unexpectedly separated.

7. The cooking vessel of claim 1, wherein a drainage hole penetrated in a horizontal direction is formed in the shaft coupling hole formed in an upper surface of the rotating member to facilitate washing of the shaft coupling hole.

8. The cooking vessel of claim 1, wherein an auxiliary stirring rod is separably provided at a first side of the stirring blade, wherein the auxiliary stirring rod is used for being separated from the stirring blade or being coupled to the stirring blade depending on types of food materials.
